(19) United States
(12) Patent Application Publication
(10) Pub. No.: US 2019/0069266 A1
(43) Pub. Date: Feb. 28, 2019

(54) METHOD AND APPARATUS FOR DETERMINING LOCATION BY USING IDENTIFICATION INFORMATION CORRESPONDING TO EXTERNAL ELECTRONIC DEVICE

(71) Applicant: Samsung Electronics Co., Ltd., Gyeonggi-do (KR)

(72) Inventors: Hun-Taek HAN, Gyeonggi-do (KR); Ji-Hyeoung SONG, Gyeonggi-do (KR); Chan-Woo LEE, Gyeonggi-do (KR); Hyun-Sang JUNG, Gyeonggi-do (KR); Eol CHOI, Seoul (KR)

(73) Assignee: Samsung Electronics Co., Ltd.

(21) Appl. No.: 16/109,193

(22) Filed: Aug. 22, 2018

(30) Foreign Application Priority Data
Aug. 22, 2017 (KR) 10-2017-0105897

(51) Int. Cl. H04W 64/00; H04L 29/08; H04W 4/029; H04W 8/18

(52) U.S. Cl. CPC H04W 64/003; H04W 8/183; H04W 4/029; H04L 67/18

(57) ABSTRACT

Disclosed is an electronic device that determines its location by using identification information corresponding to an external electronic device. The electronic device includes a communication circuit configured to communicate with an external electronic device, a location determining circuit, and a processor configured to identify first location information associated with the electronic device by using the communication circuit or the location determining circuit, to determine at least one server device among a plurality of server devices capable of providing location-related information, based on at least the first location information, to transmit identification information corresponding to the external electronic device to the at least one server device wherein the at least one server device determines second location information associated with the electronic device by using the identification information, and to determine a location of the electronic device by using the second location information.

### CROSS-REFERENCE TO RELATED APPLICATION(S)

This application is based on and claims priority under 35 U.S.C. § 119 to Korean Patent Application No. 10-2017-0105897, filed on Aug. 22, 2017, in the Korean Intellectual Property Office, the disclosure of which is incorporated by reference herein in its entirety.

### BACKGROUND

### 1. Field

The disclosure relates generally to an electronic device, and more particularly, to a method and apparatus for determining a location by using identification information corresponding to an external electronic device.

### 2. Description of Related Art

A location determining method using a network location provider (NLP) involves transmitting a cell identification (ID) received from a base station (BS) in the vicinity of an electronic device and/or an access point (AP) ID received from a nearby AP to an NLP server, and determining a current location of the electronic device based on location information received from the NLP server.

The NLP is an auxiliary device for identifying a location mainly in a shadow zone, such as indoors where a global navigation satellite system (GNSS) is not available or a region where a GNSS signal is weak. The NLP may directly identify a location merely with communication with the NLP server, and thus, is used to identify an approximate location before determining a location with the indoor GNSS. Due to high response speed, the NLP tends to incur less battery consumption in location determination than the GNSS.

The NLP server generates and stores a database (DB) of location information corresponding to each cell ID and/or AP ID, determines a location of the electronic device based on data (cell ID and/or AP ID) received from the electronic device, and transmits the determined location to the electronic device. Thus, the capacity of the DB stored in the NLP server is a key factor for determining location accuracy, as the location accuracy depends on the capacity of the DB stored in the NLP server.

Conventionally, an electronic device is capable of using only one NLP (or NLP server). As a result, the accuracy of location information may be compromised in a particular condition, and one NLP included in the electronic device may not operate.

Due to high dependency on the NLP server, if the NLP server is unstable or a network condition is not good, failure tends to occur in obtaining the location information from the NLP server. The accuracy of the location information may be determined depending on the capacity of the DB stored in the NLP server. For example, if the AP ID is not received because of absence of the AP around the electronic device, the NLP server determines the location information with the cell ID received from the electronic device, resulting in a substantial location determination error. When determining the location information with the cell ID due to a failure in receiving the AP ID from the electronic device, the NLP may transmit the unavailable location information to the electronic device. The NLP server may have a different responding speed for a different country or may not operate depending on a government policy of each country.

As such, there is a need in the art for a method and apparatus that prevent a loss in accuracy of the location information determination of the electronic device.

### SUMMARY

The present disclosure has been made to address the above-mentioned problems and disadvantages, and to provide at least the advantages described below.

Accordingly, an aspect of the present disclosure is to provide a method and apparatus that determine a location of the electronic device by using identification information corresponding to an external electronic device.

In accordance with an aspect of the disclosure, an electronic device is provided, which includes a communication circuit configured to communicate with an external electronic device, a location determining circuit, and a processor configured to identify first location information associated with the electronic device by using the communication circuit or the location determining circuit, to determine at least one server device among a plurality of server devices capable of providing location-related information, based on at least the first location information, to transmit identification information corresponding to the external electronic device to the at least one server device wherein the at least one server device determines second location information associated with the electronic device by using the identification information, and to determine a location of the electronic device by using the second location information.

In accordance with another aspect of the disclosure, a method is provided for determining a location of an electronic device. The method includes identifying first location information associated with the electronic device by using the communication circuit or the location determining circuit, determining at least one server device among a plurality of server devices capable of providing location-related information, based on at least the first location information, transmitting identification information corresponding to the external electronic device to the at least one server device wherein the at least one server device determines second location information associated with the electronic device by using the identification information, and determining a location of the electronic device by using the second location information.

In accordance with another aspect of the disclosure, a non-transitory computer readable storage medium is provided, which stores therein instructions that, when executed by at least one processor, cause the at least one processor to perform a method including identifying first location information associated with the electronic device, determining at least one server device among a plurality of server devices capable of providing location-related information, based on at least the first location information, transmitting identification information corresponding to the external electronic device to the at least one server device wherein the at least one server device determines second location information associated with the electronic device by using the identification information, and determining a location of the electronic device by using the second location information.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 is a block diagram illustrating an electronic device in a network environment according to an embodiment;

FIG. 2 illustrates a location determining system according to an embodiment;

FIG. 3 illustrates a location data collecting system according to an embodiment;

FIG. 4 is a block diagram of an electronic device according to an embodiment;

FIG. 5 illustrates a method for determining a location of an electronic device according to an embodiment;

FIG. 6 illustrates a method for determining a location of an electronic device according to an embodiment;

FIG. 7 illustrates a method for determining a location of an electronic device according to an embodiment;

FIG. 8 illustrates a method for determining a location of an electronic device according to an embodiment; and

FIG. 9 illustrates a method for determining a location of an electronic device according to an embodiment.

Throughout the drawings, like reference numerals will be understood to refer to like parts, components, and structures.

### DETAILED DESCRIPTION

Hereinafter, embodiments of the present disclosure are described with reference to accompanying drawings. Embodiments and terms used herein are not intended to limit the technologies described in the present disclosure to specific embodiments, but include modifications, equivalents, and/or alternatives on the corresponding embodiments described herein. Descriptions of well-known functions and/or configurations will be omitted for the sake of clarity and conciseness.

In describing the accompanying drawings, similar reference numerals may be used to designate similar elements. A singular expression may include a plural expression unless they are definitely different in a context. In the present disclosure, the expressions “A or B”, “at least one of A and/or B”, and “A/B” may include all possible combinations of the items listed. The expressions “a first”, “a second”, “the first”, or “the second” used in the present disclosure may modify various components regardless of order and/or importance and is not intended to limit the corresponding components. When an element (e.g., a first element) is referred to as being “(functionally or communicatively) connected,” or “directly coupled” to another element (e.g., a second element), the element may be connected directly to the other element or connected to the other element through yet another element (e.g., a third element).

The expression “configured to” as used in the present disclosure may be interchangeably used with, for example, the expressions “suitable for”, “having the capacity to”, “designed to”, “adapted to”, “made to”, and “capable of” in terms of hardware or software, according to circumstances. Alternatively, in some situations, the expression “device configured to” may indicate that the device, together with other devices or components, “is able to”. For example, the expression “processor adapted (or configured) to perform A, B, and C” may indicate a dedicated processor (e.g., an embedded processor) only for performing the corresponding operations or a general-purpose processor (e.g., a central processing unit (CPU) or an application processor that can perform the corresponding operations by executing one or more software programs stored in a memory device.

An electronic device according to an embodiment of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), an moving picture experts group (MPEG-1) audio layer-3 (MP3) player, a mobile medical device, a camera, and a wearable device. A wearable device may include at least one of an accessory type (e.g., a watch, a ring, a bracelet, an anklet, a necklace, glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit). An electronic device may include at least one of, for example, a television, a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV™), a game console (e.g., Xbox® and PlayStation®), an electronic dictionary, an electronic key, a camcorder, and an electronic photo frame.

In an embodiment of the present disclosure, an electronic device may include at least one of various medical devices (e.g., various portable medical measuring devices (e.g., a blood glucose monitoring device, a heart rate monitoring device, a blood pressure measuring device, a thermometer, etc.), a magnetic resonance angiography (MRA) device, a magnetic resonance imaging (MRI) device, a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automated teller machine (ATM) in banks, a point of sales (POS) device in a shop, or an Internet of things (IoT) device (e.g., a light bulb, various sensors, an electric or gas meter, a sprinkler device, a fire alarm, a thermostat, a streetlamp, a toaster, sporting goods, a hot water tank, a heater, a boiler, etc.).

An electronic device may include at least one of a part of furniture or a building/structure, an electronic board, an electronic signature receiving device, a projector, and various types of measuring instruments (e.g., a water meter, an electric meter, a gas meter, a radio wave meter, and the like). An electronic device may be flexible, or may be a combination of one or more of the aforementioned various devices. However, an electronic device is not intended to be limited to the above described devices. In the present disclosure, the term “user” may indicate a person using an electronic device or a device (e.g., an artificial intelligence electronic device) using an electronic device.

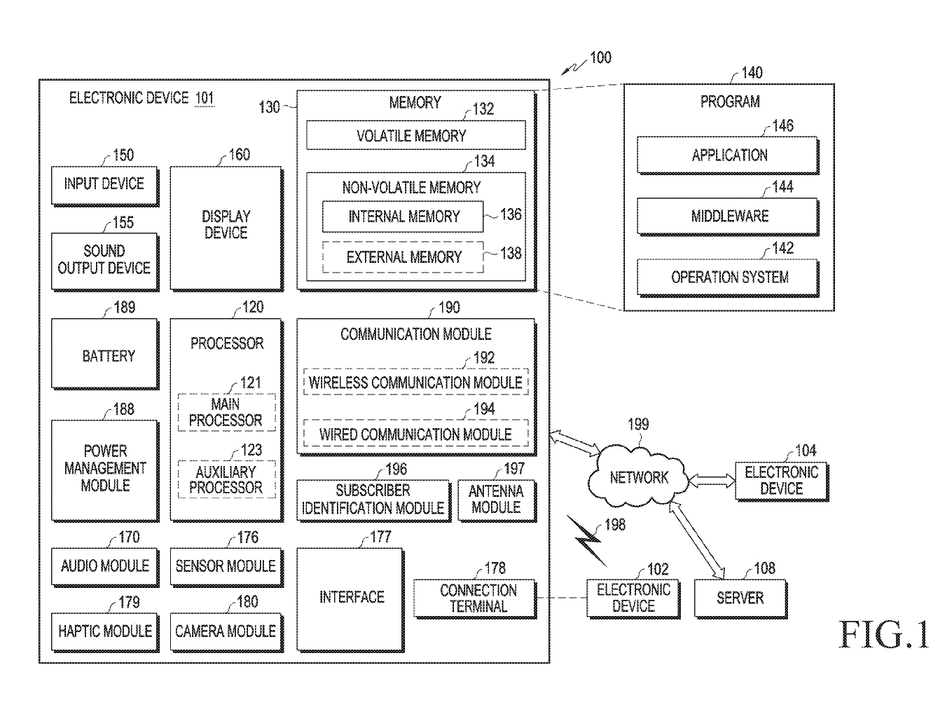

FIG. 1 is a block diagram illustrating an electronic device 101 in a network environment 100 according to an embodiment.

Referring to FIG. 1, the electronic device 101 may communicate with an electronic device 102 via a first network 198 (e.g., a short-range wireless communication network), an electronic device 104 or a server 108 via a second network 199 (e.g., a long-range wireless communication network), or the electronic device 104 via the server 108.

The electronic device 101 includes a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) card 196, and an antenna module 197. In some embodiments, at least one of the components may be omitted from the electronic device 101, other components may be added in the electronic device 101, a fingerprint sensor, an iris sensor, or an illumination sensor may be embedded in the display 160, and some components may be integrated for implementation.

The processor 120 may execute software (e.g., a program 140) to control at least one other component hardware or software component of the electronic device 101 coupled with the processor 120, may perform various data processing and computation, may load a command or data received from another component in volatile memory 132, process the command or the data stored in the volatile memory 132, and store resulting data in non-volatile memory 134. The processor 120 may include a main processor 121 (e.g., a central processing unit (CPU) or an application processor), and an auxiliary processor 123 (e.g., a graphics processing unit (GPU), an image signal processor (ISP), a sensor hub processor, or a communication processor (CP)) that is operable independently from the main processor 121, additionally or alternatively uses lower power than the main processor 121, or is specialized for a designated function. The auxiliary processor 123 may be implemented as separate from, or as part of the main processor 121.

The auxiliary processor 123 may control at least some of functions or states related to at least one component among the components of the electronic device 101, instead of the main processor 121 while the main processor 121 is in an inactive (e.g., sleep) state, or in conjunction with the main processor 121 while the main processor 121 is in an active state (e.g., executing an application). The auxiliary processor 123, such as an image signal processor or a communication processor, may be implemented as part of another component functionally related to the auxiliary processor 123. The memory 130 stores various data used by at least one component of the electronic device 101, such as software and input data or output data regarding a command associated therewith, and may include the volatile memory 132 and the non-volatile memory 134.

The program 140 is software stored in the memory 130, and may include an operating system (OS) 142, middleware 144, and at least one application 146.

The input device 150 receives a command or data to be used by another component of the electronic device 101, from the outside (e.g., a user) of the electronic device 101, and may include a microphone, a mouse, and a keyboard.

The sound output device 155 outputs an audio signal to the outside of the electronic device 101, and may include a speaker used for a general purposes such as multimedia playback or record playbacks, and a receiver used for receiving a call. The receiver may be implemented as separate from, or as part of the speaker.

The display device 160 visually provides information to the user of the electronic device 101, and may include a display, a hologram device, or a projector, control circuitry to control a corresponding one of the display, hologram device, and projector, and touch circuitry or a pressure sensor capable of measuring the strength of a touch pressure.

The audio module 170 bi-directionally converts sound and an electric signal, and may obtain the sound via the input device 150 or output the sound via the sound output device 155 or a headphone of an external electronic device wiredly or wirelessly coupled with the electronic device 101.

The sensor module 176 may detect an internal operational state (e.g., power or temperature) of the electronic device 101 or an environmental state (e.g., a state of a user) external to the electronic device 101, and then generate an electrical signal or data value corresponding to the detected state. The sensor module 176 may include at least one of a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and an illuminance sensor.

The interface 177 may support a designated protocol for wired or wireless connection with the external electronic device and may include at least one of a high definition multimedia interface (HDMI), a universal serial bus (USB) interface, a secure digital (SD) card interface, and an audio interface.

A connection terminal 178 may include a connector capable of physically connecting the electronic device 101 with an external electronic device, such as an HDMI connector, a USB connector, an SD connector, and an audio connector (e.g., a headphone connector).

The haptic module 179 may convert an electrical signal into a mechanical stimulus (e.g., a vibration or a movement) or electrical stimulus which may be recognized by a user via tactile or kinesthetic sensation, and may include a motor, a piezoelectric element, or an electric stimulator.

The camera module 180 may capture a still image or moving images and may include one or more lenses, image sensors, image signal processors, and flashes.

The power management module 188 manages power supplied to the electronic device 101 and may be as at least a part of a power management integrated circuit (PMIC).

The battery 189 supplies power to at least one element of the electronic device 101, and may include at least one of a non-rechargeable primary battery, a rechargeable secondary battery, and a fuel cell.

The communication module 190 may support establishment of a wired communication channel or a wireless communication channel between the electronic device 101 and the external electronic device, and communication via the established communication channel, may include one or more communication processors that are operable independently from the processor 120 and support a wired communication or a wireless communication, may include a wireless communication module 192 (e.g., a cellular communication module, a short-range wireless communication module, or a GNSS communication module) or a wired communication module 194 (e.g., a local area network (LAN) communication module or a power-line communication module), and may communicate with the external electronic device via the first network 198 (e.g., a short-range communication network, such as Bluetooth™, Wi-Fi direct, or infrared data association (IrDA)) or the second network 199 (e.g., a long-range communication network, such as a cellular network, the Internet, or a computer network (e.g., a LAN or wide area network (WAN)). The above-described various types of the communication module 190 may be implemented with a single chip or separate chips.

The wireless communication module 192 identifies and authenticates the electronic device 101 in a communication network by using user information stored in the SIM card 196.

The antenna module 197 may include one or more antennas for transmitting or receiving a signal or power to or from the outside. The communication module 190 may transmit or receive a signal to or from an external electronic device via an antenna suitable for a communication scheme.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic device 102 and the electronic device 104 may be of the same type as or a different type than the electronic device 101. Some or all of operations performed by the electronic device 101 may be performed in another electronic device or a plurality of other electronic devices. When the electronic device 101 has to perform a function or a service automatically or at a request, the electronic device 101 may request an external electronic device to perform at least some functions associated with the function or the service, instead of or in addition to executing the function or the service. The external electronic device having received the request may execute the requested function or additional function and deliver the execution result to the electronic device 101, which may then process the received result to provide the requested function or service. To this end cloud computing, distributed computing, or client-server computing may be used.

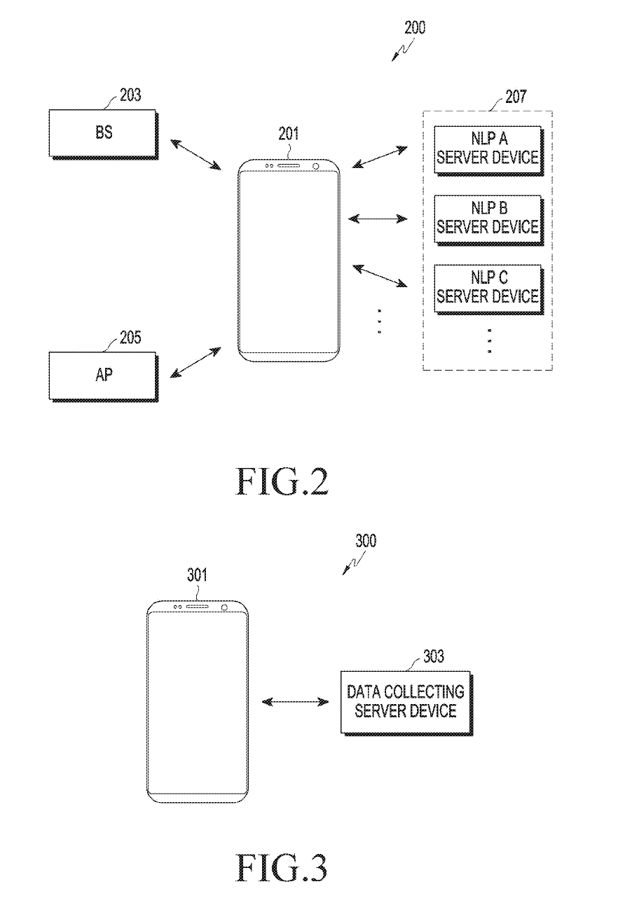

FIG. 2 illustrates a location determining system according to an embodiment.

Referring to FIG. 2, a location determining system 200 includes an electronic device 201, at least one base station (BS) 203, at least one AP 205, and a plurality of NLP server devices 207.

The electronic device 201 determines at least one NLP server device from among the plurality of NLP server devices 207 based on at least one of first location information or state information of the electronic device 201 and determines a current location of the electronic device 201 by using second location information received from the at least one NLP server device.

The electronic device 201 obtains identification information corresponding to an external electronic device (e.g., the BS 203 or the AP 205) located near the electronic device 201 and transmits the identification information to the at least one NLP server device, which determines the second location information of the electronic device 201.

The identification information may include a cell ID associated with the at least one BS 203 that is located near the electronic device 201 and is searched by the electronic device 201 and/or an AP ID associated with the at least one AP 205.

The identification information may include Bluetooth™ (BT) information or/and Bluetooth™ Low Energy (BLE) information that is broadcast through a BLE module of an external electronic device located near the electronic device 201.

The electronic device 201 determines location information matching a condition among at least one piece of location information included in the second location information received from the at least one NLP server device (e.g., estimated horizontal accuracy information or/and a reception time of the second location information) as current location information of the electronic device 201.

Each of the plurality of NLP server devices 207 may include a memory having stored therein location information corresponding to the identification information, upon receiving the identification information from the electronic device 201, and the NLP server devices 207 determine the second location information corresponding to the identification information based on the memory, and transmit the determined second location information to the electronic device 201.

FIG. 3 illustrates a location data collecting system according to an embodiment.

Referring to FIG. 3, the location data collecting system 300 includes an electronic device 301 and a data collecting server device 303.

Once the electronic device 301 determines the current location information thereof by using the at least one of the plurality of NLP server devices, the electronic device 301 transmits the determined location information thereof and information associated with the location determination thereof to the data collecting server device 303, which calculates an average accuracy of an NLP server device for each place and stores information about at least one NLP server device available in each place and source information (e.g., a cell ID or an AP ID) necessary for using the at least one NLP server device. The information associated with the location determination of the electronic device may include information about an NLP server device having received location information that may be used to determine the current location of the electronic device and identification information (e.g., a cell ID or/and an AP ID) used by the NLP server device to determine the location of the electronic device.

The electronic device 301 receives information about at least one server device among the plurality of NLP server devices from the data collecting server device 303 based on the first location information of the electronic device 301, and transmits identification information (e.g., a cell ID or/and an AP ID) for the location determination of the electronic device 301 to the at least one server device.

The electronic device 301 receives information about at least one server device among the plurality of NLP server devices from the data collecting server device 303 based on the first location information of the electronic device 301 or state information of the electronic device 301, such as a roaming state, a SIM card state, or an AP-detectable state of the electronic device 301, and transmits identification information for the location determination of the electronic device 301 to the at least one server device.

The data collecting server device 303 receives the location information of the electronic device 301 and the information associated with the location determination of the electronic device 301 from a plurality of electronic devices including the electronic device 301 and calculates an average accuracy of the NLP server device for each place by using the information received from the plurality of electronic devices. The data collecting server device 303 stores information about at least one NLP server device available for each place and source information needed for use of the at least one NLP server device in a memory of the data collecting server device 303, based on the average accuracy of the NLP server device calculated for each place.

Upon receiving the first location information from the electronic device 301, the data collecting server device 303 determines at least one NLP server device available in a first location from among the plurality of NLP server devices in the memory of the data collecting server device 303 having stored the information about the at least one NLP server device available for each place and the source information needed for use of the at least one NLP server device based on the average accuracy of the NLP server device calculated for each place, and transmits information about the determined at least one NLP server device to the electronic device 301.

Upon receiving the first location information from or the state information of the electronic device 301 from the electronic device 301, the data collecting server device 303 determines at least one NLP server device available in the first location from among the plurality of NLP server devices in the memory of the data collecting server device 303 having stored the information about the at least one NLP server device available for each place and the source information needed for use of the at least one NLP server device based on the average accuracy of the NLP server device calculated for each place. The data collecting server device 303 may transmit the information about the at least one NLP server device available for each place and the source information needed for use of the at least one NLP server device (e.g., a cell ID or an AP ID) to the electronic device 301.

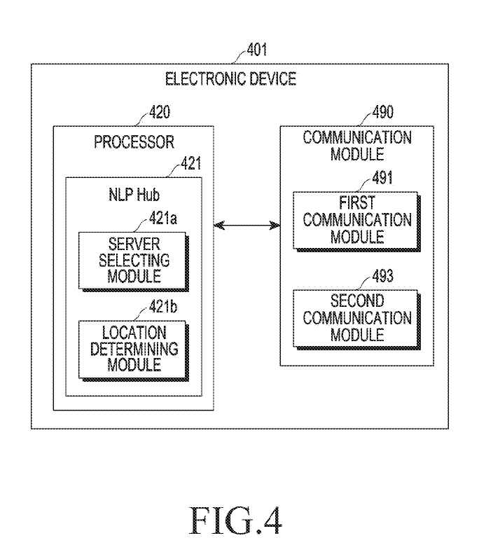

FIG. 4 is a block diagram of an electronic device 401 according to an embodiment.

Referring to FIG. 4, the electronic 401 includes a processor 420 and a communication module 490.

The processor 420 may include an NLP hub 421 capable of selecting and using at least one NLP server device out of the plurality of NLP server devices, and being included in the processor 420 in the form of an application, and may also be included in the electronic device 401 as a separate module from the processor 420. The NLP hub 421 may include a server selecting module 421a and a location determining module 421b.

The server selecting module 421a identifies first location information of the electronic device 401 upon booting of the electronic device 401, start of an NLP function, or reception of a request for location information by at least one executed application, and determines at least one NLP server device that is currently available among the plurality of NLP server devices based on the first location information.

The server selecting module 421a identifies the first location information (e.g., a country or a region) regarding a location where the electronic device 401 is currently located, based on at least one of information including a mobile country code (MCC) and a mobile network code (MNC) received through a first communication module 491 or current location information identified using a second communication module 493.

The server selecting module 421a may determine the at least one NLP server device currently available among the plurality of NLP server devices based on the first location information of the electronic device 401. For example, when MCC information of the electronic device 401 is identified as indicating China (e.g., a specific code 460 of predetermined codes corresponding to a plurality of countries), the server selecting module 421a may determine at least one NLP server device, such as an NLP server of Samsung™, Google™, or Baidu™ available in China among the plurality of NLP server devices.

The server selecting module 421a identifies the first location information of the electronic device 401 or the state information of the electronic device 401 upon booting of the electronic device 401, start of an NLP function, or reception of a request for location information by at least one executed application, and determines at least one NLP server device that is currently available among the plurality of NLP server devices based on the first location information or the state information. The state information of the electronic device 401 may include a roaming, SIM card insertion, and AP-detectable state of the electronic device 401.

The server selecting module 421a may identify the state information of the electronic device 401 and determine the at least one NLP server device currently available based on the state information of the electronic device 401. For example, when the state information of the electronic device 401 includes an AP-non-detectable state, the processor 420 may determine at least one NLP server device having stored therein place information data (e.g., a large amount of place information data) based on cell ID information from among the plurality of NLP server devices. When the state information of the electronic device 401 includes a SIM card-withdrawn state, the processor 420 may determine at least one NLP server device having stored therein the place information data based on AP ID information from among the plurality of NLP server devices. When the electronic device 401 is in the roaming state, the processor 401 may determine at least one NLP server device available in a place where the electronic device 401 is currently located.

The server selecting module 421a may determine at least one first NLP server device among a plurality of NLP server devices based on at least one of the first location information of the electronic device 401 and/or accessibility to each NLP server device, and determine at least one second NLP server device among the at least one first NLP server device based on the state information of the electronic device 401.

The server selecting module 421a transmits identification information corresponding to an external electronic device searched by and located near the electronic device 401 to the at least one NLP server device determined based on the first location information of the electronic device 401 or the state information of the electronic device 401. The at least one NLP server device determines second location information of the electronic device 401.

The server selecting module 421a may obtain identification information corresponding to an external electronic device located near the electronic device 401.

The server selecting module 421a may receive, as the identification information, a cell ID received from the BS 203 or/and an AP ID received from the AP 205 located near the electronic device 401.

The server selecting module 421a may receive, as the identification information, BT information or/and BLE information broadcast through a BLE module of the external electronic device located near the electronic device 401.

The server selecting module 421a re-determines at least one NLP server device based on changed first location information of the electronic device 401, even after determining at least one NLP server device among the plurality of NLP server devices (e.g., 207 of FIG. 2) based on the first location information of the electronic device 401. When determining that the first location information of the electronic device 401 is changed, the server selecting module 421a determines at least one NLP server device among the plurality of NLP server devices based on the changed first location information.

The server selecting module 421a may determine whether the first location information of the electronic device 401 is changed, by periodically or aperiodically (e.g., at the request of a user) identifying at least one piece of information (e.g., an MCC or an MNC) of the electronic device 401 received through the first communication module 491 or the current location information of the electronic device 401, identified using the second communication module 493.

The location determining module 421b determines a location of the electronic device 401 by using the second location information received from the at least one NLP server device determined based on the first location information of the electronic device or the state information of the electronic device.

The second location information may include at least one piece of location information received from each of the at least one NLP server devices.

The location determining module 421b may determine, as the location of the electronic device 401, location information having the highest accuracy among the at least one piece of location information included in the second location information. For example, when the second location information includes the first location information having a first accuracy and the second location information having a second accuracy, the location determining module 421b may determine, as the location of the electronic device 401, one location determined between the first location information and the second location information, at least based on a comparison result between the first accuracy and the second accuracy.

The location determining module 421b may determine the accuracy of the at least one piece of location information included in the second location information, based on at least one of estimated horizontal accuracy information (e.g., in meter (m) units) or time information associated with the location information.

The time information associated with the location information may include at least one of a location fix time or a response time.

The location fix time indicates a time needed for an NLP server device to determine the second location information based on the identification information received from the electronic device 401, and may be received together with the estimated horizontal accuracy information (e.g., in m units) through the second location information.

The response time indicates a duration from sending a request for the location information including the identification information to the NLP server device to receiving the second location information determined based on the identification information from the NLP server device. The electronic device 401 may calculate and determine the response time.

The location determining module 421b may determine the location of the electronic device 401, based on at least one of estimated horizontal accuracy information or time information associated with location information. For example, the location determining module 421b may determine, as the location of the electronic device 401, location information including the smallest units (e.g., in m units) of the estimated horizontal accuracy information, among the at least one piece of location information included in the second location information. For example, the location determining module 421b may determine, as the location of the electronic device 401, location information including the time information indicating a shortest time in receiving the location information, based on the time information associated with the location information (e.g., the location fix time or the response time), among the at least one piece of location information included in the second location information.

The location determining module 421b may identify the location information that may be determined as the location of the electronic device 401 among the at least one piece of location information included in the second location information, by applying a specific weight value to at least one of the estimated horizontal accuracy information and the time information associated with the location information (e.g., the location fix time or the response time).

The location determining module 421b may identify the location information that may be determined as the location of the electronic device 401 based on at least one of the estimated horizontal accuracy information and the time information associated with the location information, depending on a type of an application sending a request for the location information. For example, when the application sending the request for the location information is a navigation or map application that gives high priority to the estimated horizontal accuracy information, the processor 420 may determine, as the location of the electronic device 401, location information having the smallest units of estimated horizontal accuracy information among the at least one piece of location information included in the second location information. For example, when the application requesting the location information is a weather application that gives high priority to the time information associated with the location information, the processor 420 may determine, as the location of the electronic device 401, the location information received in the shortest time among the at least one piece of location information included in the second location information.

The location determining module 421b may receive and store the second location information every designated time (e.g., 5 seconds), which may be changed according to a network state or at the request of the user, unless it is fixed.

After identifying the location information that may be determined as the location of the electronic device 401 among the at least one piece of location information included in the second location information, the location determining module 421b may transmit the location information to the application requesting the location information.

After determining one of the at least one piece of location information included in the second location information received from the at least one NLP server device as the location of the electronic device 401, the processor 420 transmits the determined location information of the electronic device 401 and information associated with the location determination of the electronic device 401 to the data collecting server device, which uses the information as data for calculating the average accuracy of the NLP server device to store at least one NLP server device available for each place.

The information associated with the location determination of the electronic device 401 may include information about an NLP server device having received the location information that may be determined as the location of the electronic device 401 and a type of identification information (e.g., a cell ID or/and an AP ID) used by the NLP server device to determine the location of the electronic device 401.

Alternatively, the information associated with the location determination of the electronic device 401 may include information about a weight value applied to the identification when the NLP server device determines the location information by using the identification information. For example, when among location information received from the LP servers of Samsung™, Google™, and Baidu™, the processor 420 determines location information A received from the NLP server device of Samsung™ as the current location information of the electronic device 401 and the NLP server device of Samsung™ determines the location information A by using an AP ID, the processor 420 transmits information about the NLP server device of Samsung™ and the AP ID information to the data collecting server device through the first communication module 491.

The processor 420 transmits server request information including at least one of the first location information and the state information of the electronic device 401 to the data collecting server device, and upon receiving information about at least one server device among the plurality of NLP server devices from the data collecting server device, transmits identification information for the location determination of the electronic device 301 to the at least one NLP server device which determines the second location information associated with the electronic device 401 by using the identification information.

For example, when transmitting the first location information A of the electronic device 401 to the data collecting server device, the processor 420 may receive the information about the at least one NLP server device (e.g., the NLP server device of Samsung™ and use of AP ID information) available in the first location information A from the data collecting server device. The processor 420 obtains the AP ID information as the identification information based on the information about the at least one NLP server device received from the data collecting server device, transmits the obtained AP ID information to the NLP server device of Samsung™, and receives the second location information from the NLP server device of Samsung™.

The electronic device 401 may further include a memory having stored therein at least one application capable of requesting location determination, and an application capable of controlling at least one data associated with an NLP.

The memory may store information about a plurality of NLP server devices, from which at least one NLP server device is determined based on at least one of the first location information of the electronic device 401 and the state information of the electronic device 401.

The memory may store an NLP server device, information about a place where the NLP server device is available, and a type of identification information used by the NLP server device to determine location information. For example, information including “Samsung's NLP server device, a place A, and use of an AP ID” may be stored in the memory.

The information about the plurality of NLP server devices stored in the memory may be periodically or aperiodically updated by a separate server managing the plurality of NLP server devices.

According to an embodiment, another electronic device (e.g., the server 108 of FIG. 1 or a server managing an NLP server device) may include a memory that may store information about a plurality of NLP server devices from which at least one NLP server device is determined based on at least one of the first location information received from the electronic device and the state information of the electronic device.

The memory included in the other electronic device may store an NLP server device, information about a place where the NLP server device is available, and a type of identification information used by the NLP server device to determine location information.

The communication module 490 may include the first communication module 491 and the second communication module 493.

The first communication module 491 is a network location determining module and may include a cellular communication module and/or a short-range communication module. The cellular communication module and/or the short-range communication module may receive a cell ID from a nearby BS and/or an AP ID from an AP.

A cell may refer to a region on the ground in which each BS of a ground communication system is capable of providing a communication service to an electronic device. The electronic device may receive information indicating a sector of a BS, i.e., a cell ID or a cell location from the BS. Information about the communication cell may be a cell ID or a cell location included in or extracted from a signal received by the electronic device from the BS, or information similar thereto. The electronic device may determine (or approximate) the cell location as a location of the electronic device.

The cellular communication module and/or the short-range communication module transmits the identified at least one cell ID and/or AP ID information to at least one server device among the plurality of NLP server devices and receives location information from the at least one NLP server devices. The first communication module 491 may further include a BT communication module and/or a BLE communication module, identify BT information and/or BLE information broadcast from a nearby external electronic device through the BT module and/or BLE module, and transmit the identified information to the at least one NLP server device through the cellular communication module and/or the short-range communication module.

The second communication module 493 may include a GNSS communication module and determines the location of the electronic device based on at least one information received from a satellite.

The GNSS may include at least one of a global positioning system (GPS), a global navigation satellite system (GLONASS), Galileo, or a compass system also known as Beidou-2. Satellites (or space vehicles (SVs)) may be configured to transmit navigation signals for reception by the GNSS communication module that may be configured to calculate the location of the electronic device from the received navigation signals. The GNSS module processes received signals and performs location determination for displaying the current location.

As described above, disclosed is an electronic device which includes a communication circuit configured to communicate with an external electronic device, a location determining circuit, and a processor which is configured to identify first location information associated with the electronic device by using the communication circuit or the location determining circuit, to determine at least one server device among a plurality of server devices capable of providing location-related information, at least based on the first location information, to transmit identification information corresponding to the external electronic device to the at least one server device that determines second location information associated with the electronic device by using the identification information, and to determine a location of the electronic device by using the second location information.

The processor may be configured to receive the second location information from the at least one server device through the communication circuit in response to the transmission of the identification information to the at least one server device.

The second location information may include a first location having a first accuracy and a second location having a second accuracy, the first location and the second location being determined at least based on the identification information, and the processor may be further configured to determine one, which is determined between the first location and second location, as the location of the electronic device, at least based on a result of a comparison between the first accuracy and the second accuracy.

The processor may be further configured to compare the first accuracy with the second accuracy based on estimated horizontal accuracy information or time information associated with a location fix time or a response time.

The processor may be further configured to identify state information of the electronic device and to determine at least one of the plurality of server devices based on the state information of the electronic device.

The processor may be further configured to determine whether the first location information is changed and to determine at least one of the plurality of server devices at least based on the changed first location information when determining that the first location information is changed.

The processor may be further configured to transmit the determined location information of the electronic device and information associated with the location determination of the electronic device to a data collecting server device that calculates an accuracy of the location information for each place.

The processor may be further configured to transmit the first location information to the data collecting server device through the communication circuit and to receive information about at least one of the plurality of server devices from the data collecting server device through the communication circuit in response to the transmission of the first location information to the data collecting server device.

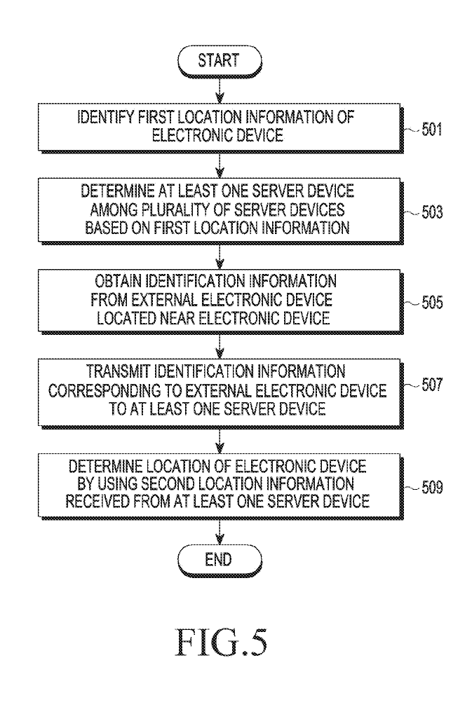

FIG. 5 illustrates a method for determining a location of an electronic device according to an embodiment. The method of FIG. 5, and each of the methods to be described below, may be performed by at least one of the electronic devices in FIGS. 1-4, at least one processor in FIG. 1 or FIG. 4, or a controller of the electronic device. In FIG. 5, a plurality of server devices or at least one server device may include the plurality of NLP server devices 207 of FIG. 2 or at least one NLP server device.

In step 501, the electronic device identifies first location information thereof upon booting of the electronic device, start of an NLP function, or reception of a request for location information by at least one executed application.

The electronic device may identify first location information (e.g., a country or a region) where the electronic device is currently located, by using at least one piece of information (an MCC or an MNC) of the electronic device received through a first communication module or a second communication module.

In step 503, the electronic device determines at least one server device among a plurality of server devices based on the first location information of the electronic device.

The electronic device may determine at least one server device available in the first location information of the electronic device in a memory having stored therein information about the plurality of server devices of the electronic device or a memory of another electronic device.

In step 505, the electronic device obtains identification information from an external electronic device located near the electronic device. The external electronic device (e.g., a BS 203 of FIG. 2 or an AP 205 of FIG. 2) may be located near the electronic device and be searched by the electronic device. For example, the external electronic device may be a nearest AP (or a BS) among a plurality of connectable APs (or BSs). For example, the electronic device may be an AP (or a BS) being currently connected among a plurality of connectable APs (or BSs). The external electronic device may communicate with the electronic device using wired or/and wireless connection (e.g., cellular network or a short-range communication network) to transmit (or broadcast) the identification information.

The electronic device may obtain a cell ID associated with at least one BS that is located near the electronic device and is searched by the electronic device and/or an AP ID associated with at least one AP as identification information through the first communication module.

In step 507, the electronic device transmits the identification information corresponding to at least one external electronic device to the at least one server device through the first communication module.

The electronic device may transmit the cell ID and/or the AP ID received from the BS and/or the AP through the first communication module to the at least one server device wherein the at least one server device determines second location information associated with the electronic device by using the cell ID and/or the AP ID.

In step 509, upon receiving the second location information calculated based on identification information corresponding to at least one external electronic device received by at least one server device from the electronic device, from the at least one server device through the first communication module, the electronic device determines the location thereof by using the second location information.

The electronic device may determine location information having higher accuracy and higher reception speed among at least one piece of location information received from at least one server device in the second location information as the location of the electronic device.

The electronic device may determine the accuracy of the at least one piece of location information included in the second location information based on at least one of estimated horizontal accuracy information and time information associated with the location information. The location fix time indicates a time needed for an NLP server device to determine the second location information based on the identification information received from the electronic device, and may be included in the second location information together with the estimated horizontal accuracy information. The response time indicates a duration from sending a request for the location information including the identification information to the NLP server device to receiving the second location information determined based on the identification information from the NLP server device, and the electronic device may determine the response time.

The electronic device may determine, as the location of the electronic device, location information including at least one of smallest units of estimated horizontal accuracy information or shorter time information based on the time information associated with the location information among the at least one piece of location information included in the second location information.

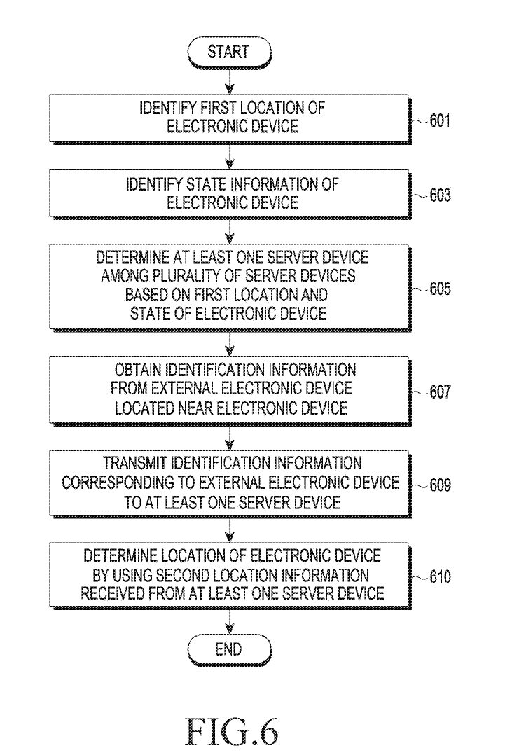

FIG. 6 illustrates a method for determining a location of an electronic device according to an embodiment. In FIG. 6, a plurality of server devices or at least one server device may include the plurality of NLP server devices 207 of FIG. 2 or at least one NLP server device.

In step 601, the electronic device identifies first location information thereof upon booting of the electronic device 401, start of an NLP function, or reception of a request for location information by at least one executed application.

The electronic device may identify first location information where the electronic device is currently located, by using at least one of an MCC and an MNC of the electronic device received through a first communication module or a second communication module.

In step 603, the electronic device identifies state information of the electronic device, such as a roaming, SIM card insertion, and AP-detectable state of the electronic device.

In step 605, the electronic device determines at least one server device among a plurality of server devices based on the first location information of the electronic device or the state information of the electronic device.

The electronic device may determine at least one server device available in a memory having stored therein information about the plurality of server devices based on the state information of the electronic device.

The electronic device may determine at least one server device available in the first location information of the electronic device in the memory having stored therein the information about the plurality of server devices and determine the at least one server device available among the at least one server device based on the state information of the electronic device.

In step 607, the electronic device obtains identification information from an external electronic device located near the electronic device. The external electronic device (e.g., a BS 203 of FIG. 2 or an AP 205 of FIG. 2) may be located near the electronic device and be searched by the electronic device. For example, the external electronic device may be a nearest AP (or a BS) among a plurality of connectable APs (or BSs). For example, the electronic device may be an AP (or a BS) being currently connected among a plurality of connectable APs (or BSs). The external electronic device may communicate with the electronic device using wired or/and wireless connection (e.g., cellular network or a short-range communication network) to transmit (or broadcast) the identification information.

The electronic device may obtain a cell ID associated with at least one BS that is located near the electronic device and is searched by the electronic device and/or an AP ID associated with at least one AP as identification information through the first communication module.

In step 609, the electronic device transmits the identification information corresponding to at least one external electronic device to the at least one server device through the first communication module, wherein the at least one server device determines second location information associated with the electronic device.

In step 610, upon receiving the second location information calculated based on identification information corresponding to at least one external electronic device received by at least one server device from the electronic device, from the at least one server device through the first communication module, the electronic device determines the location thereof (i.e., determines its own location) by using the second location information.

The electronic device may determine location information having higher accuracy and higher reception speed among at least one piece of location information received from at least one server device in the second location information as the location of the electronic device.

The electronic device may determine the accuracy of the at least one piece of location information included in the second location information based on at least one of estimated horizontal accuracy information or time information associated with the location information (e.g., a location fix time or a response time). The location fix time indicates a time needed for an NLP server device to determine the second location information based on the identification information received from the electronic device, and may be included in the second location information together with the estimated horizontal accuracy information. The response time indicates a duration from sending a request for the location information including the identification information to the NLP server device to receiving the second location information determined based on the identification information from the NLP server device, and the electronic device may determine the response time.

The electronic device may determine, as the location of the electronic device, location information including at least one of smallest units of estimated horizontal accuracy information or shorter time information based on the time information associated with the location information among the at least one piece of location information included in the second location information.

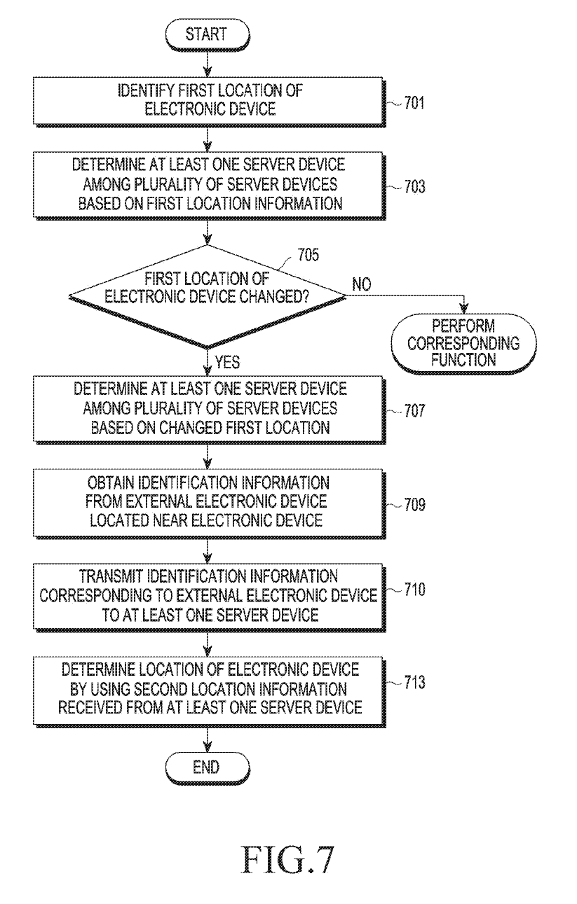

FIG. 7 illustrates a method for determining a location of an electronic device according to an embodiment. In FIG. 7, a plurality of server devices or at least one server device may include the plurality of NLP server devices 207 of FIG. 2 or at least one NLP server device.

In step 701, the electronic device identifies first location information thereof upon booting of the electronic device, start of an NLP function, or reception of a request for location information by at least one executed application.

The electronic device may identify first location information where the electronic device is currently located, by using at least one of an MCC and an MNC of the electronic device received through a first communication module or a second communication module.

In step 703, the electronic device determines at least one server device among a plurality of server devices based on the first location information of the electronic device.

The electronic device may determine at least one server device available in the first location information of the electronic device in the memory having stored therein the information about the plurality of server devices.

In step 705, the electronic device periodically or aperiodically determines whether the first location information of the electronic device is changed.

The electronic device may determine whether the first location information of the electronic device is changed, by using at least one of an MCC and an MNC of the electronic device received through a first communication module or a second communication module.

When determining that the first location information of the electronic device is changed in step 705, the electronic device determines at least one server device available in the changed first location of the electronic device in the memory having stored therein the information about the plurality of server devices, in step 707.

In step 709, the electronic device obtains identification information from an external electronic device located near the electronic device. The external electronic device (e.g., a BS 203 of FIG. 2 or an AP 205 of FIG. 2) may be located near the electronic device and be searched by the electronic device. For example, the external electronic device may be a nearest AP (or a BS) among a plurality of connectable APs (or BSs). For example, the electronic device may be an AP (or a BS) being currently connected among a plurality of connectable APs (or BSs). The external electronic device may communicate with the electronic device using wired or/and wireless connection (e.g., cellular network or a short-range communication network) to transmit (or broadcast) the identification information.

The electronic device may obtain a cell ID associated with at least one BS that is located near the electronic device and is searched by the electronic device and/or an AP ID associated with at least one AP as identification information through the first communication module.

In step 710, the electronic device transmits the identification information corresponding to at least one external electronic device to the at least one server device through the first communication module, wherein the at least one server device determines second location information associated with the electronic device.

In step 713, upon receiving the second location information calculated based on identification information corresponding to at least one external electronic device received by at least one server device from the electronic device, from the at least one server device through the first communication module, the electronic device determines the location thereof (i.e., its own location) by using the second location information.

The electronic device may determine location information having higher accuracy and higher reception speed among at least one piece of location information received from at least one server device in the second location information as the location of the electronic device.

As described above, the electronic device may determine the accuracy of the at least one piece of location information included in the second location information based on at least one of estimated horizontal accuracy information and time information associated location fix time or a response time. The location fix time indicates a time needed for an NLP server device to determine the second location information based on the identification information received from the electronic device, and may be included in the second location information together with the estimated horizontal accuracy information. The response time indicates a duration from sending a request for the location information including the identification information to the NLP server device to receiving the second location information determined based on the identification information from the NLP server device, and the electronic device may determine the response time.

The electronic device may determine, as the location of the electronic device, location information including at least one of smallest units of estimated horizontal accuracy information or shorter time information based on the time information associated with the location information among the at least one piece of location information included in the second location information.

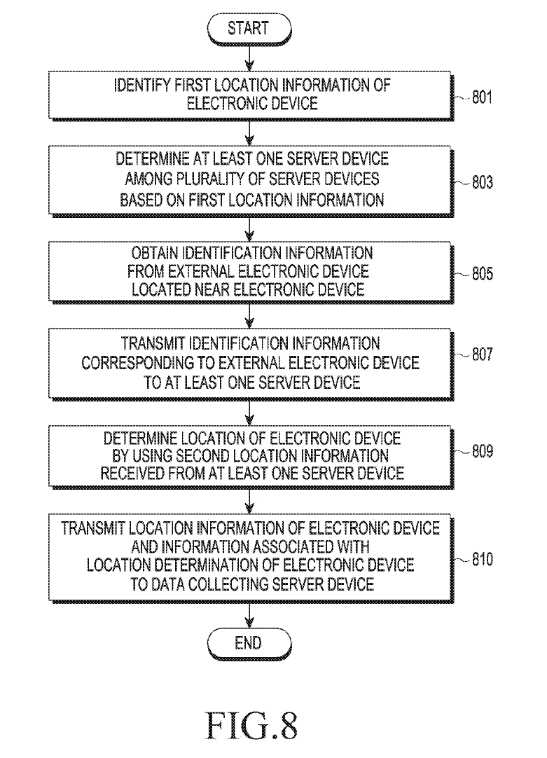

FIG. 8 illustrates a method for determining a location of an electronic device according to an embodiment. In FIG. 8, a plurality of server devices or at least one server device may include the plurality of NLP server devices 207 of FIG. 2 or at least one NLP server device.

In step 801, the electronic device identifies first location information thereof upon booting of the electronic device 401, start of an NLP function, or reception of a request for location information by at least one executed application.

The electronic device may identify first location information where the electronic device is currently located, by using at least one of an MCC and an MNC of the electronic device received through a first communication module or a second communication module.

In step 803, the electronic device determines at least one server device available in the first location of the electronic device among the plurality of server devices in a memory having stored therein information about the plurality of server devices of the electronic device or a memory of another electronic device, based on the first location information of the electronic device.

In step 805, the electronic device obtains identification information from an external electronic device located near the electronic device.

The electronic device may obtain a cell ID associated with at least one BS that is located near the electronic device and is searched by the electronic device and/or an AP ID associated with at least one AP as identification information through the first communication module.

The electronic device may transmit the identification information corresponding to at least one external electronic device to the at least one server device through the first communication module, wherein the at least one NLP server device determines second location information associated with the electronic device by using the identification information.

In step 809, upon receiving the second location information calculated based on identification information corresponding to at least one external electronic device received by at least one server device from the electronic device, from the at least one NLP server device through the first communication module, the electronic device determines the location thereof by using the second location information.

The electronic device may determine location information having higher accuracy and higher reception speed among at least one piece of location information received from at least one server device in the second location information as the location of the electronic device.

The electronic device may determine the accuracy of the at least one piece of location information included in the second location information based on at least one of estimated horizontal accuracy information or time information associated with the location fix time or response time. The location fix time indicates a time needed for an NLP server device to determine the second location information based on the identification information received from the electronic device, and may be included in the second location information together with the estimated horizontal accuracy information. The response time indicates a duration from sending a request for the location information including the identification information to the NLP server device to receiving the second location information determined based on the identification information from the NLP server device, and the electronic device may determine the response time.

The electronic device may determine, as the location of the electronic device, location information including at least one of smallest units of estimated horizontal accuracy information or location information including time information indicating a shortest time in receiving the location information, among the at least one piece of location information included in the second location information.

In step 810, once determining one of the at least one piece of location information included in the second location information received from the at least one server device as the location of the electronic device, the electronic device transmits the determined location information of the electronic device and the information associated with the location determination of the electronic device to the data collecting server device.

The electronic device may transmit the location information thereof determined using the second location information, and the information associated with the location determination thereof to the data collecting server device, which calculates an average accuracy of an NLP server device for each place and stores information about at least one NLP server device available in each place and source information necessary for using the at least one NLP server device.

The information associated with the location determination of the electronic device may include information about a server device having received the location information that may be determined as the location of the electronic device and a type of identification information used by the server device to determine the location of the electronic device.

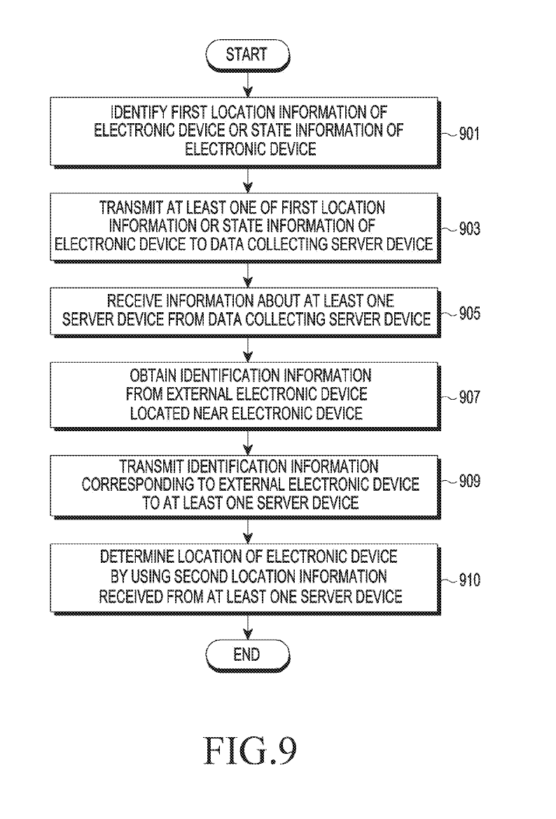

FIG. 9 illustrates a method for determining a location of an electronic device according to an embodiment. In FIG. 9, a plurality of server devices or at least one server device may include the plurality of NLP server devices 207 of FIG. 2 or at least one NLP server device.

In step 901, the electronic device identifies at least one of the first location information thereof and the state information thereof upon booting of the electronic device, start of an NLP function, or reception of a request for location information by at least one executed application.

The electronic device may identify first location information where the electronic device is currently located, by using at least one of an MCC or an MNC of the electronic device received through a first communication module or a second communication module.

The state information of the electronic device may include a roaming state, a SIM card state, and an AP-detectable state of the electronic device.

In step 903, the electronic device transmits at least one of the first location information of the electronic device or the state information of the electronic device to the data collecting server device.

When identifying at least one of the first location information of the electronic device or the state information of the electronic device, the electronic device transmits server request information including at least one of the first location information thereof or the state information thereof to the data collecting server device.

In step 905, the electronic device receives information about at least one available server device from the data collecting server device based on at least one of the first location information thereof and the state information thereof.

The electronic device may receive information about at least one server device available in the first location and source information needed for using the at least one server device from the data collecting server device, based on at least one of the first location information of the electronic device or the state information of the electronic device.

In step 907, the electronic device obtains identification information from an external electronic device located near the electronic device.

The electronic device may obtain a cell ID associated with at least one BS that is located near the electronic device and is searched by the electronic device and/or an AP ID associated with at least one AP as identification information through the first communication module.

In step 909, the electronic device transmits the identification information corresponding to at least one external electronic device to the at least one server device through the first communication module.

The electronic device may transmit the cell ID and/or the AP ID received from the BS and/or the AP through the first communication module to the at least one server device wherein the at least one server device determines second location information associated with the electronic device by using the cell ID and/or the AP ID.

In step 910, upon receiving the second location information (e.g., location information calculated based on identification information corresponding to at least one external electronic device received by at least one server device from the electronic device) from the at least one server device through the first communication module, the electronic device determines the location thereof by using the second location information.

The electronic device may determine location information having higher accuracy and higher reception speed among at least one piece of location information received from at least one server device in the second location information as the location of the electronic device.

The electronic device may determine the accuracy of the at least one piece of location information included in the second location information, based on at least one of estimated horizontal accuracy information or time information associated with the location information.

As described above, each of the at least one piece of location information included in the second location information includes at least one of the estimated horizontal accuracy information or the time information associated with the location fix time or response time, and may determine, as the location of the electronic device, location information including the smallest units of estimated horizontal accuracy information or the shortest time information for receiving the location information, based on the time information associated with the location information among the at least one piece of location information included in the second location information.

The location fix time indicates a time needed for an NLP server device to determine the second location information based on the identification information received from the electronic device, and may be included, in the second location information, together with the estimated horizontal accuracy information. The response time indicates a duration from sending a request for the location information including the identification information to the NLP server device to receiving the second location information determined based on the identification information from the NLP server device, and the electronic device may determine the response time.

The electronic device may determine, as the location of the electronic device, location information including at least one of the smallest units of estimated horizontal accuracy information or location information including time information indicating a shortest time in receiving the location information, among the at least one piece of location information included in the second location information.

As described above, according to various embodiments, a method for determining a location of an electronic device includes identifying first location information associated with the electronic device by using the communication circuit or the location determining circuit, determining at least one server device among a plurality of server devices capable of providing location-related information, at least based on the first location information, transmitting identification information corresponding to the external electronic device to the at least one server device wherein the at least one server device determines second location information associated with the electronic device by using the identification information, and determining a location of the electronic device by using the second location information.

The method may further include receiving the second location information from the at least one server device through the communication circuit in response to the transmission of the identification information to the at least one server device.

The second location information may include a first location having a first accuracy and a second location having a second accuracy, the first location and the second location being determined at least based on the identification information, and the method may further include determining one, which is determined between the first location and second location, as the location of the electronic device, at least based on a result of comparison between the first accuracy and the second accuracy.

The method may further include comparing the first accuracy with the second accuracy based on estimated horizontal accuracy information or time information associated with the location fix time or response time.

The method may further include identifying state information of the electronic device and determining at least one of the plurality of server devices further based on the state information of the electronic device.

The method may further include determining whether the first location information is changed and determining at least one of the plurality of server devices at least based on the changed first location information when determining that the first location information is changed.

The method may further include transmitting the determined location information of the electronic device and information associated with the location determination of the electronic device to a data collecting server device that calculates an accuracy of the location information for each place.

The method may further include transmitting the first location information to the data collecting server device through the communication circuit and receiving information about at least one of the plurality of server devices from the data collecting server device through the communication circuit in response to the transmission of the first location information to the data collecting server device.

As used herein, the term “module” may include a unit implemented in hardware, software, or firmware, and may interchangeably be used with other terms, such as logic, logic block, part, or circuitry, may be a part configured integrally, a minimum unit or a portion thereof performing one or more functions, and may be implemented mechanically or electronically and may include an application-specific integrated circuit (ASIC) chip, field-programmable gate arrays (FPGAs), and a programmable-logic device performing operations already known or to be developed.

At least a part of an apparatus (e.g., modules or functions thereof) or a method (e.g., operations) according to various embodiments may be implemented with an instruction stored in a computer-readable storage medium in the form of a programming module. When the instructions are executed by a processor, the processor may perform functions corresponding to the instructions. The computer-readable recording medium includes hard disk, floppy disk, or magnetic media (e.g., a magnetic tape, optical media (e.g., compact disc read only memory (CD-ROM) or digital versatile disc (DVD), magneto-optical media (e.g., floptical disk), an embedded memory, and so forth. The instructions may include a code generated by a compiler or a code executable by an interpreter.

According to various embodiments, a storage medium has stored therein instructions that, when executed by at least one processor, cause the at least one processor to perform at least one operation including identifying first location information associated with the electronic device, determining at least one server device among a plurality of server devices capable of providing location-related information, at least based on the first location information, transmitting identification information corresponding to the external electronic device to the at least one server device wherein the at least one server device determines second location information associated with the electronic device by using the identification information, and determining a location of the electronic device by using the second location information.

Modules or programming modules according to embodiments of the present disclosure may include one or more of the foregoing elements, have some of the foregoing elements omitted, or further include additional other elements. Operations performed by the module, the program, or another component according to various embodiments may be carried out sequentially, in parallel, repeatedly, or heuristically, or one or more of the operations may be executed in a different order or omitted, or one or more other operations may be added.

According to the embodiments, the accuracy of the location information of the electronic device may be improved by using a plurality of NLP server devices and location information obtained from the plurality of NLP server device. In addition, the location information of the electronic device may be requested by switching to an NLP server device available in the current place among the plurality of NLP server devices. Moreover, information about a new NLP server device in addition to the plurality of NLP server devices stored in the memory may be added and used, and the location information of the electronic device obtained using the plurality of NLP server devices may be transmitted to the data collecting server device, and the NLP server device available in the current place may be determined using the data collecting server device.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. An electronic device, comprising:
a communication circuit configured to communicate with an external electronic device;
a location determining circuit; and
a processor configured to:
identify first location information associated with the electronic device by using the communication circuit or the location determining circuit;
determine at least one server device among a plurality of server devices capable of providing location-related information, based on at least the first location information;
transmit identification information corresponding to the external electronic device to the at least one server device, wherein the at least one server device determines second location information associated with the electronic device by using the identification information; and
determine a location of the electronic device by using the second location information.

2. The electronic device of claim 1, wherein the processor is further configured to receive the second location information from the at least one server device through the communication circuit in response to the transmission of the identification information to the at least one server device.

3. The electronic device of claim 1,
wherein the second location information comprises a first location having a first accuracy and a second location having a second accuracy, the first location and the second location being determined based on at least the identification information, and
wherein the processor is further configured to determine one of the first location and second location, as the location of the electronic device, based on at least a result of a comparison between the first accuracy and the second accuracy.

4. The electronic device of claim 3, wherein the processor is further configured to compare the first accuracy with the second accuracy based on at least one of estimated horizontal accuracy information or time information associated with location information.

5. The electronic device of claim 1, wherein the processor is further configured to identify state information of the electronic device and to determine at least one of the plurality of server devices based on the state information of the electronic device.

6. The electronic device of claim 1, wherein the processor is further configured to determine whether the first location information is changed, and to determine at least one of the plurality of server devices based on at least the changed first location information when determining that the first location information is changed.

7. The electronic device of claim 1, wherein the processor is further configured to transmit the determined location information of the electronic device and information associated with the location determination of the electronic device to a data collecting server device that calculates an accuracy of the location information for each place corresponding to the at least one server device.

8. The electronic device of claim 1, wherein the processor is further configured to:
transmit the first location information to a data collecting server device through the communication circuit; and
receive information about at least one of the plurality of server devices from the data collecting server device through the communication circuit in response to the transmission of the first location information to the data collecting server device.

9. A method for determining a location of an electronic device, the method comprising:
identifying first location information associated with the electronic device;
determining at least one server device among a plurality of server devices capable of providing location-related information, based on at least the first location information;
transmitting identification information corresponding to an external electronic device to the at least one server device, wherein the at least one server device determines second location information associated with the electronic device by using the identification information; and
determining a location of the electronic device by using the second location information.

10. The method of claim 9, further comprising receiving the second location information from the at least one server device in response to the transmission of the identification information to the at least one server device.

11. The method of claim 9,
wherein determining the location of the electronic device comprises:
determining one of a first location having a first accuracy and a second location having a second accuracy, as the location of the electronic device, based on at least a result of a comparison between the first accuracy and the second accuracy, and
wherein the second location information comprises the first location having the first accuracy and the second location having the second accuracy, the first location and the second location being determined based on at least the identification information.

12. The method of claim 11, further comprising comparing the first accuracy with the second accuracy based on at least one of estimated horizontal accuracy information or time information associated with location information.

13. The method of claim 9, further comprising:
identifying state information of the electronic device; and
determining at least one of the plurality of server devices based on the state information of the electronic device.

14. The method of claim 9, further comprising:
determining whether the first location information is changed; and
determining at least one of the plurality of server devices at least based on the changed first location information when determining that the first location information is changed.

15. The method of claim 9, further comprising transmitting the determined location information of the electronic device and information associated with the location determination of the electronic device to a data collecting server device that calculates an accuracy of the location information for each place corresponding to the at least one server device.

16. The method of claim 9, further comprising:
transmitting the first location information to a data collecting server device; and
receiving information about at least one of the plurality of server devices from the data collecting server device in response to the transmission of the first location information to the data collecting server device.

17. A non-transitory computer readable storage medium having stored therein instructions which, when executed by at least one processor, causes the at least one processor to perform a method which comprises:
identifying first location information associated with the electronic device;
determining at least one server device among a plurality of server devices capable of providing location-related information, based on at least the first location information;
transmitting identification information corresponding to the external electronic device to the at least one server device, wherein the at least one server device determines second location information associated with the electronic device by using the identification information; and
determining a location of the electronic device by using the second location information.

18. The method of claim 17, wherein determining the location of the electronic device comprises:
determining one between a first location and a second location, as the location of the electronic device, based on at least a result of a comparison between the first accuracy and the second accuracy, and
wherein the second location information comprises the first location having a first accuracy and the second location having a second accuracy, the first location and the second location being determined based on at least the identification information.

19. The method of claim 17, further comprising:
identifying state information of the electronic device; and
determining at least one of the plurality of server devices based on the state information of the electronic device.

20. The method of claim 17, further comprising transmitting the determined location information of the electronic device and information associated with the location determination of the electronic device to a data collecting server device that calculates an accuracy of the location information for each place corresponding to the at least one server device.
